(19) United States
(12) Patent Application Publication
(10) Pub. No.: US 2011/0128229 A1
(43) Pub. Date: Jun. 2, 2011

(54) TERMINAL AND SLIDING APPARATUS

(75) Inventors: Seung Hwan LEE, Seoul (KR); Hyung Jin KIM, Gwangmyeong-si (KR)

(73) Assignee: PANTECH CO., LTD., Seoul (KR)

(21) Appl. No.: 12/953,360

(22) Filed: Nov. 23, 2010

(30) Foreign Application Priority Data
Nov. 30, 2009 (KR) 10-2009-0117343

(51) Int. Cl. G06F 3/02; F16C 35/02

(52) U.S. Cl. 345/168; 384/24

(57) ABSTRACT

A terminal includes two bodies facing each other of which one of the two bodies inclinedly slides relative to the other body. The terminal may include a first body, a second body facing the first body, and a sliding apparatus to inclinedly slide the first body and the second body between a first position in which the first body and the second body face each other and a second position in which the second body is inclined with respect to the first body. The sliding apparatus converts a sliding force exerted in a linear direction to a rotation force in a rotation direction.

### CROSS-REFERENCE TO RELATED APPLICATION

This application claims priority from and the benefit under 35 U.S.C. §119(a) of Korean Patent Application No. 10-2009-0117343, filed on Nov. 30, 2009, the disclosure of which is incorporated herein by reference for all purposes.

### BACKGROUND

1. Field

Exemplary embodiments relate to a terminal including two bodies facing each other of which one of the two bodies inclinedly slides relative to the other body and a sliding apparatus of the terminal.

2. Discussion of the Background

Examples of general terminals by which a user transmits/receives signals with is another party include mobile communication terminals by which the user communicates with another party even when the user is moving, e.g., a cellular phone, a personal communication service (PCS) phone, a personal digital assistant (PDA), and the like. General terminals may be classified into a bar-type, a flip type, a folder type, a slide type, and the like, and may be selected based on convenience and portability desired by the user. Such various types of mobile communication terminals may be further classified based on a display panel on which information is displayed and input keys through information is inputted.

The folder type terminal may generally include an upper body and a lower body connected to each other by a hinge, and a display panel may be mounted on both of an upper surface and a lower surface of the upper body, or mounted only on one of the upper surface and the lower surface of the upper body. Here, to use the display panel mounted only on one surface of the upper body, it may be cumbersome for a user to unfold the upper body.

The slide type terminal may generally include an upper body having a display panel formed thereon to be always exposed to the outside and a lower body in which a region of the lower body is selectively opened by a sliding movement of the upper body. In this instance, when the upper body of the slide type terminal slides relative to the lower body of the slide type terminal by a distance, the input keys mounted in the lower body may be generally exposed.

In addition, in a case of the general slide type terminal, a sliding mechanism to perform a sliding operation may be separately mounted in the terminal, and thereby only a portion of the lower body may be exposed, resulting in limited use of the lower body.

Also, in a case of the general slide type terminal, the upper body slides parallel to the lower body. Specifically, the upper body and the lower body slide along a plane while keeping a distance spaced between the upper body and the lower body. Accordingly, an inconvenience may occur where the user should manipulate the upper body to align information displayed through the slid upper body with a viewing angle of the user, or in that the user should slouch to face the terminal.

Also, in a case in which multimedia services, such as moving pictures and the like, are provided using the terminal, it may be cumbersome and inconvenient for a user to use a separate holding stand for the terminal to adjust the viewing angle in order to view the multimedia services for an extended period of time.

### SUMMARY

Exemplary embodiments provide a terminal including two bodies facing each other of which one of the two bodies inclinedly slides relative to the other body, and provide a sliding apparatus of the terminal.

Exemplary embodiments provide a terminal which may expose a front surface of one of two bodies of which one inclinedly slides relative to the other, and provide a sliding apparatus of the terminal.

Exemplary embodiments provide a terminal which may slide an upper body even with a relatively small force.

Additional features of the invention will be set forth in the description which follows, and in part will be apparent from the description, or may be learned by practice of the invention.

An exemplary embodiment provides a terminal including a first body; a second body facing the first body; and a sliding apparatus to inclinedly slide the second body with respect to the first body between a first position in which the first body and the second body face each other and a second position in which the second body is inclined with respect to the first body by converting a sliding force exerted in a linear direction to a rotation force in a rotation direction, the sliding force being applied to the second body towards the second position.

Exemplary embodiments provide a sliding apparatus of a terminal, the sliding apparatus including: a rotation unit to rotate a second body of the terminal relative to a first body of the terminal, the rotation unit being connected between a front end of the first body and a lower surface of the second body facing the first body; a sliding unit to slide the second body in a sliding direction or in a return direction opposite to the sliding direction; and an operation unit disposed between the rotation unit and the sliding unit to convert a sliding force of the sliding unit exerted in a linear direction in to a rotation force of the rotation unit.

Exemplary embodiments provide a sliding apparatus of a terminal, the sliding apparatus including: a first plate rotatably connected to a front end of a first body of the terminal, the first plate being connected to the first body at a first end of the first plate; a second plate disposed on a lower surface of a second body of the terminal, the lower surface of the second body facing the first body; and a third plate rotatably connected to a second end of the first plate and slidably connected to the second plate, the second end of the first plate being opposite the first end of the first plate.

It is to be understood that both the foregoing general description and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a schematic perspective view illustrating a terminal in a first position according to exemplary an embodiment.

FIG. 2 is a schematic perspective view illustrating the terminal of FIG. 1 in a second position according to an exemplary embodiment.

FIG. 3 is an exploded perspective view illustrating the terminal of FIG. 1.

FIGS. 4 through 9 are cross-sectional views used for describing movements of the terminal of FIG. 1 from a first position to a second position.

### DETAILED DESCRIPTION OF THE ILLUSTRATED EMBODIMENTS

The invention is described more fully hereinafter with reference to the accompanying drawings, in which exemplary embodiments of the invention are shown. This invention may, however, be embodied in many different forms and should not be construed as limited to the embodiments set forth herein. Rather, these exemplary embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

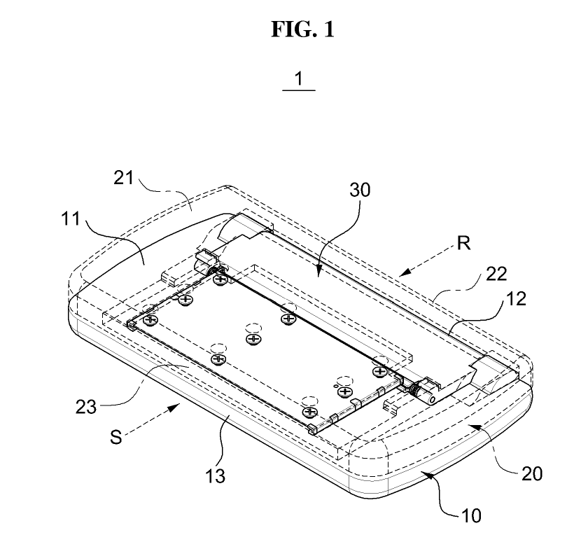

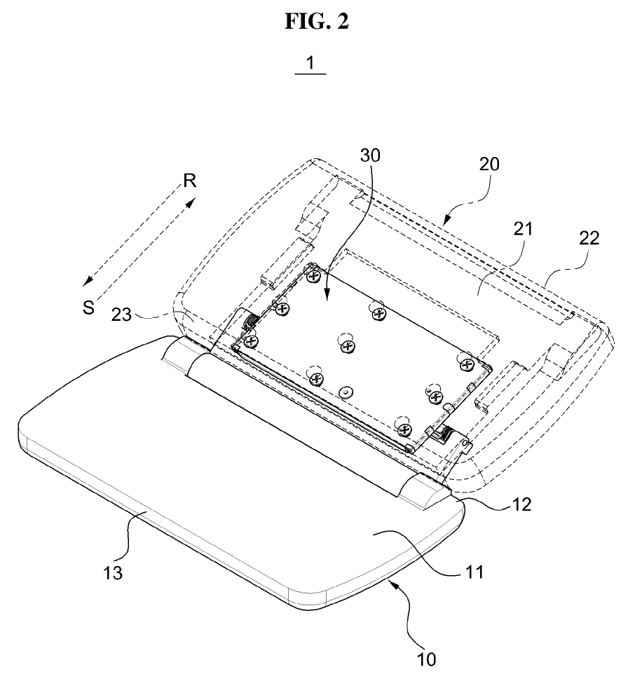

FIG. 1 is a schematic perspective view illustrating a terminal 1 in a first position according to an exemplary embodiment. FIG. 2 is a schematic perspective view illustrating the terminal of FIG. 1 in a second position according to an exemplary embodiment. Referring to FIG. 1 and FIG. 2, the terminal 1 includes a first body 10, a second body 20, and a sliding apparatus 30. The terminal 1 may be a handheld terminal, such as a mobile phone, a personal digital assistant (PDA), a digital multimedia broadcasting (DMB) equipment, and the like.

The first body 10 and the second body 20 may have a shape and size that correspond to each other, i.e., the first body 10 and the second body 20 may have a same or a similar shape. Further, the first body 10 and the second body 20 may respectively correspond to a lower body and an upper body of the terminal. Here, although not illustrated in the first body 10 and the second body 20 in detail, the terminal 1 may include input keys, a display panel, a speaker, a camera, and the like. The first body 10 may be a main body of the terminal 1 and may include input keys through which information is inputted. Here, the input keys may be formed in a front surface 11 of the first body 10, and a control substrate, a battery, and the like may be mounted in the first body 10. Also, the second body 20 may be a cover of the terminal 1 and may include a display panel on which information is displayed formed on a front surface 21 of the second body 20; however, embodiments are not limited thereto such that any surface of the first body 10 and the second body 20 may include a display panel.

The sliding apparatus 30 may inclinedly slide the first body 10 and the second body 20 with each other between a first position as illustrated in FIG. 1 in which the first body and the second body face each other and a second position as illustrated in FIG. 2 in which the second body is inclinedly slid to be positioned differently from or away from the first position. Input keys (not illustrated) mounted in the first body 10 may be hidden if the sliding apparatus 30 is positioned in the first position, and may be exposed by a movement of the second body 20 if the sliding apparatus 20 is positioned in the second position. In addition, if the second body 20 is moved to the second position, the sliding apparatus 30 may completely expose the front surface 11 of the first body 10.

For convenience of description, as illustrated in FIG. 1 and FIG. 2, a direction in which the second body 20 moves, with respect to the first body 10, from the first position to the second position may be referred to as a sliding direction S, and a direction in which the second body 20 is returned from the second position to the first position, i.e., a direction opposite to the sliding direction S, may be referred to as a return direction R. In addition, because the first body 10 and the second body 20 are moveable in the sliding direction S, respective front ends 12 and 22 and rear ends 13 and 23 of the first and second bodies 10 and 20 are determined as illustrated in FIG. 2.

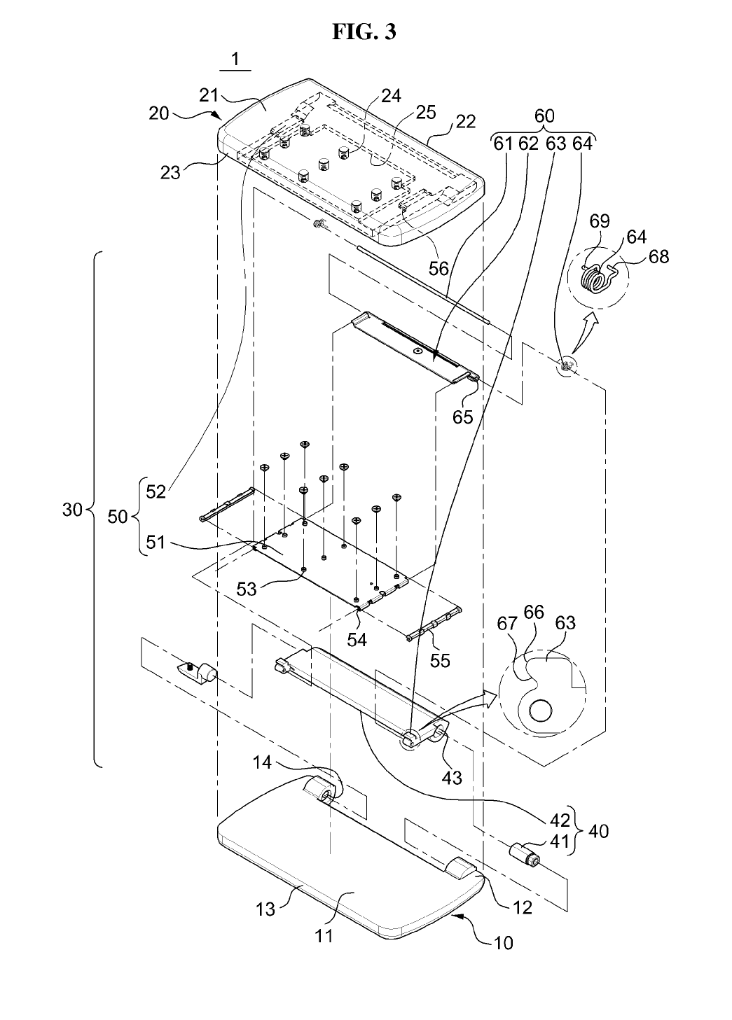

FIG. 3 is an exploded perspective view illustrating the terminal of FIG. 1. As illustrated in FIG. 3, the sliding apparatus 30 includes a rotation unit 40, a sliding unit 50, and an operation unit 60. The rotation unit 40 may be mounted between the first body 10 and the second body 20, and the rotation unit 40 may inclinedly slide the second body 20 relative to the first body 10. Here, the rotation unit 40 may inclinedly slide such that the front surface 21 of the second body 20 is always exposed. The rotation unit 40 may include a rotation hinge 41 and a first plate 42.

The rotation hinge 41 may be mounted in the front end 12 of the first body 10. In this instance, the rotation hinge 41 may be inserted into a shaft groove 14 formed at the front end 12 of the first body 10. A pair of rotation hinges 41 may be provided at the front end 12 of the first body 10 to be spaced apart from each other to provide for stable rotation operation of the rotation hinge 41. In this instance, the pair of hinges 41 may be disposed adjacent to respective ends 12 and 13 of the first body 10.

The first plate 42 may be rotatably connected to the rotation hinge 41 at a first end of the first plate 42. A hinge groove 43 into which the rotation hinge 41 is inserted and seated may be formed on the first end of the first plate 42. Accordingly, the first end of the first plate 42 may be a rotation end rotated by a connection with the rotation hinge 41, and a second end of the first plate 42 extended away from the first end of the first plate 42 may be a free end.

The sliding unit 50 may slide the second body 20 in the sliding direction S or in the return direction R over a distance without being interfered with by the rotation operation of the rotation unit 40. The sliding unit 50 may include a second plate 51 and a sliding groove 52.

The second plate 51 may be mounted in the second body 20. The second plate 51 may contact a surface of the second body 20. The second plate 51 may include a plurality of fixed protrusions 53, and the plurality of fixed protrusions 53 may be inserted into a plurality of fixed grooves 24 formed on the second body 20 so that the second plate 51 may be fixed relative to the second body 20. Here, the second plate 51 may be installed in an installation groove 25 formed on a rear surface of the second body 20, and the installation groove 25 may be recessed to be stepped. The rear surface of the second body 20 is opposite to the front surface 21 of the second body 20.

In addition, the second plate 51 may include a rail 55 formed on both ends of the second plate 51 to thereby enable the second plate 51 to be connected to a third plate 62. The rail 55 may be disposed parallel to the sliding direction S. The second plate 51 may include a rail installation groove 54 recessed to be stepped on both ends of the second plate 51, and the rail 55 may be inserted in the rail installation groove.

The sliding groove 52 may be formed on the rear surface of the second body 20 facing the first body 10 to thereby face the both ends of the second plate 51. Specifically, the sliding groove 52 may be spaced apart by a distance from both ends of the installation groove 25 where the second plate 51 is installed and may be formed parallel to the sliding direction S. Here, by a distance in which the sliding groove 52 is formed in the sliding direction S, the second plate 51 may face the front surface 11 of the first body 10, and a sliding range in which the second plate 51 independently slides may be limited.

The operation unit 60 may be mounted between the rotation unit 40 and the sliding unit 50, and convert a sliding force applied to the second body 20 into a rotation force, thereby providing an operative force by which the second body 20 inclinedly slides relative to the first body 10. For this purpose, the operation unit 60 may include a connection rod 61, the third plate 62, an operative protrusion 63, and an elastic body 64.

The connection rod 61 may be axis-coupled to the second end of the first plate 42, i.e., ends of the connection rod 61 may be disposed in grooves at the free end of the first plate 42. In this manner, the connection rod 61 may be mounted on the second end of the first plate 42 and may be orthogonal to the sliding direction S.

The third plate 62 may be rotatably connected to the connection rod 61 at one end of the third plate 62, and the third plate 62 may be connected to the second plate 51 so as not to interfere with the second plate 51 that slides in a range of the sliding groove 52. Specifically, the third plate 62 may include a rod groove 65 formed on a first end of the third plate 62 so that an outer peripheral surface of the connection rod 61 may be wound and supported and the third plate 62 may be connected to the connection rod 61. Both ends of the third plate 62 may be formed to be stepped with respect to the sliding direction S so that the both ends of the third plate 62 may be inserted into the rail 55 mounted in the both ends of the second plate 51. Accordingly, even though the second plate 51 moves in the sliding groove 52 in the sliding direction S or in the return direction R together with the second body 20, the third plate 62 supported by the rail 55 at the both ends of the third plate 62 may be inhibit the sliding movement of the second body 20.

The operative protrusion 63 may be extend from the second end of the first plate 42, and may be inserted into the sliding groove 52. A pair of sliding grooves 52 may be provided to face the both ends of the second plate 51, and thus, a pair of operative protrusions 63 may be also provided to correspond to the sliding groove 52. However, a number of the sliding grooves 52 and a number of the operative protrusions 63 inserted into the sliding grooves 52 may vary.

The operative protrusion 63 may include an end portion 66 that extends away from the first end of the first plate 42 and an inclined surface 67 inclinedly connecting the end portion 66 and the second end of the first plate 42. Here, the end portion 66 of the operative protrusion 63 may contact a side wall 56 (hereinafter, referred to as ‘contact wall’) of the sliding groove 52 adjacent to or nearer to the rear end 23 of the second body 20 if the second body 20 is slid in the sliding direction S. In addition, if a force is generated to move the second body 20 in the sliding direction S after the end portion 66 of the operative protrusion 63 is brought into contact with the contact wall 56 of the sliding groove 52, the inclined surface 67 may contact the contact wall 56, and thereby the operative protrusion 63 may move the second body 20 upwardly, and then the operative protrusion 63 may be separated from the sliding groove 52.

In addition, the operative protrusion 63 may be inserted into the sliding groove 52 to restrict a movement of the third plate 62 connected to the second end of the first plate 42. Specifically, due to a height difference between a position to which the operative protrusion 63 extends from the second end of the first plate 42 and a portion of the third plate 62 connected to the second end of the first plate 42, a movement of the second end of the first plate 42 may be restricted in a state where the operative protrusion 63 is inserted into the sliding groove 52, and a movement of the third plate 62 may be also restricted in a state of being supported by the rail 55. However, if the operative protrusion 63 is separated from the sliding groove 52, the third plate 62 may be slidably moved along the rail 55 in a state of facing the second plate 51 together with a removal of a restriction force of the first plate 42. In this manner, a position of the operative protrusion 63 immediately before the operative protrusion 63 is separated from the sliding groove 52 after being brought into contact with the contact wall 56 of the sliding groove 52 may be a curve-point at which the second body 20 automatically moves in the sliding direction S or the return direction R.

The elastic body 64 may be axis-connected to the connection rod 61 to elastically pressurize the rear end 23 of the second body 20 towards the first body 10. Here, a first end of the elastic body 64 may be fixed on or connected to the first plate 42, and a second end of the elastic body 64 may be fixed on or connected the third plate 62. In this manner, the elastic body 64 may be selectively compressed together with a rotation movement of the second end of the third plate 62 with respect to the connection rod 61 to thereby generate an automatic sliding force towards the sliding direction S or the return direction R. In addition, the elastic body 64 may elastically pressurize the second end of the third plate 62 towards the first body 10, and thereby may restrict ascending of the rear end 23 of the second body 20 even though the second body 20 inclinedly slides in the sliding direction S.

A pair of elastic bodies 64 may be provided to be coupled to both ends of the connection rod 61. However, aspects are not limited thereto such that a number of the elastic bodies 64 may be variable depending on a shape, a size, and the like of the terminal 1.

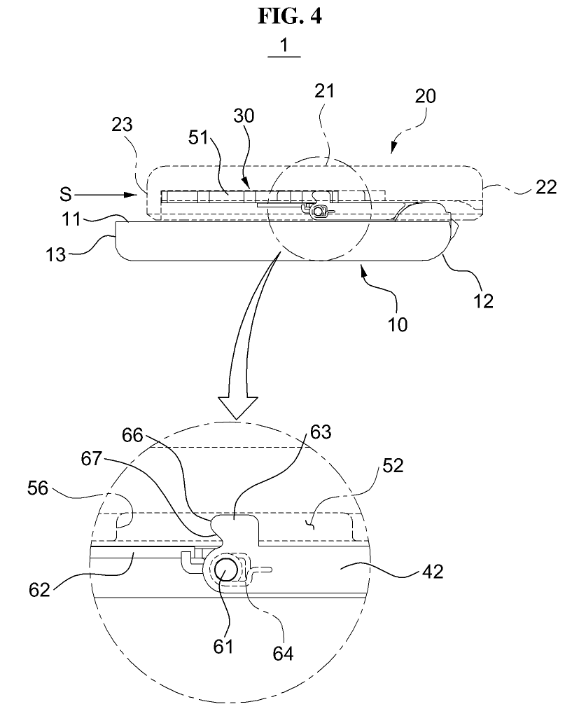

FIGS. 4 through 9 are cross-sectional views used for describing movements of the terminal of FIG. 1 from a first position to a second position. Referring to FIG. 4, a user may slide the second body 20 in the sliding direction S by a predetermined distance from the first position. In this instance, the second plate 51 mounted in the second body 20 may be moved in the sliding direction S together with a sliding movement of the second body 20. In this instance, the operative protrusion 63 formed on the second end of the first plate 42 may remain inserted into the sliding groove 52 to restrict a movement of the first plate 42. Thus, only the second plate 51 may be moved in the sliding direction S together with the second body 20, and the third plate 62 connected to the second end of the first plate 42 may be not moved together with a movement of the second body 20 while being supported by the rail 55 at the both ends of the third plate 62. In this instance, the rail 55 may be interposed between both ends of the second plate 51. In this configuration, the second body 20 may slide parallel to the first body 10 while facing the first body.

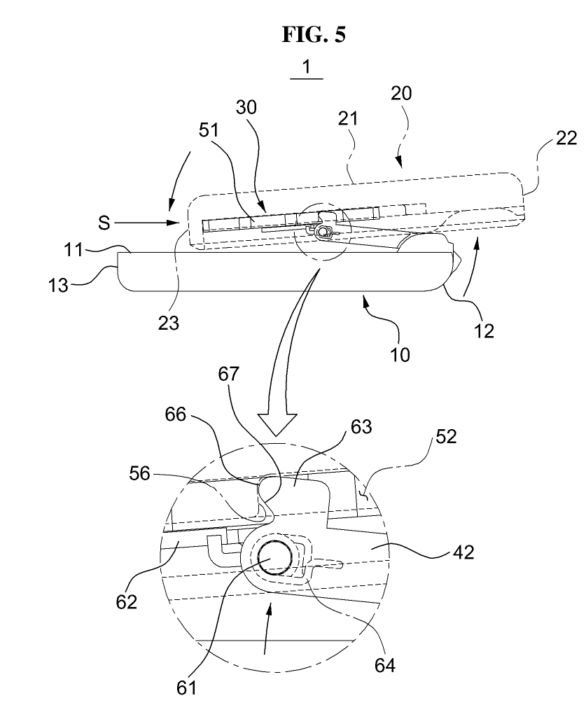

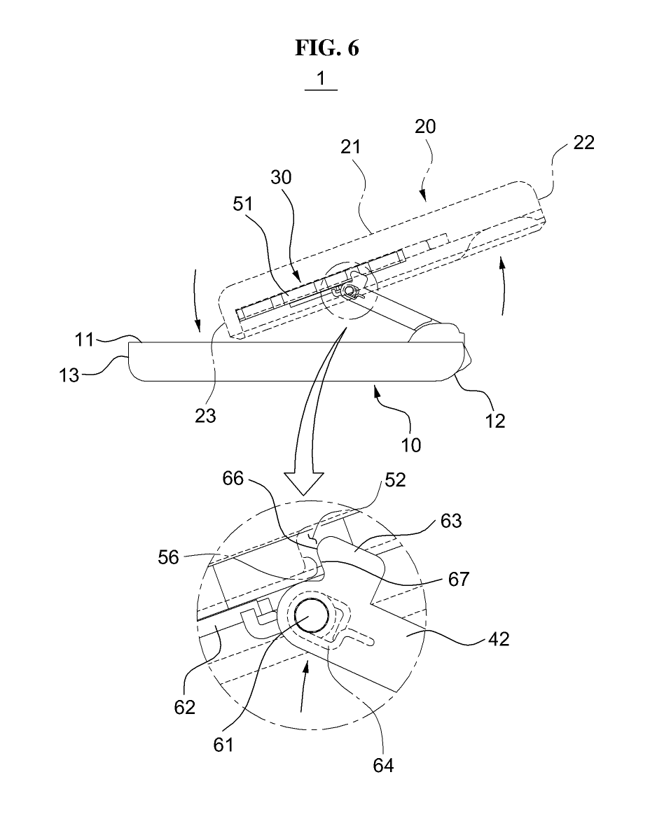

Thereafter, as illustrated in FIG. 5, if the second body 20 continues to moves in the sliding direction S, then the end portion 66 of the operative protrusion 63 contacts the contact wall 56 of the sliding groove 52. A force generated by the continued movement of the second body 20 in the sliding direction S and a reaction between the end portion 66 and the contact wall 56 upwardly moves the second end of the first plate 42 with respect to the rotation hinge 41 to raise the second body 20, as illustrated in FIG. 6. In this instance, if the inclined surface 67 contacts the contact wall 56, the movement of the second body 20 may be guided by a tilt angle of the inclined surface 67 and the contact with the second end of the first plate 42. At the same time, the rear end of the second body 20 is pressurized towards to the first body 10 by an elastic force of the elastic body 64 connected to the connection rod 61, and thereby the third plate 62 may be downwardly rotated with respect to the connection rod 61 mounted on the second end of the first plate 42. Accordingly, the rear end 23 of the second body 20 may be remain in contact with or near the first body 10 even though a movement force of the second body 20 to move to the second position is created.

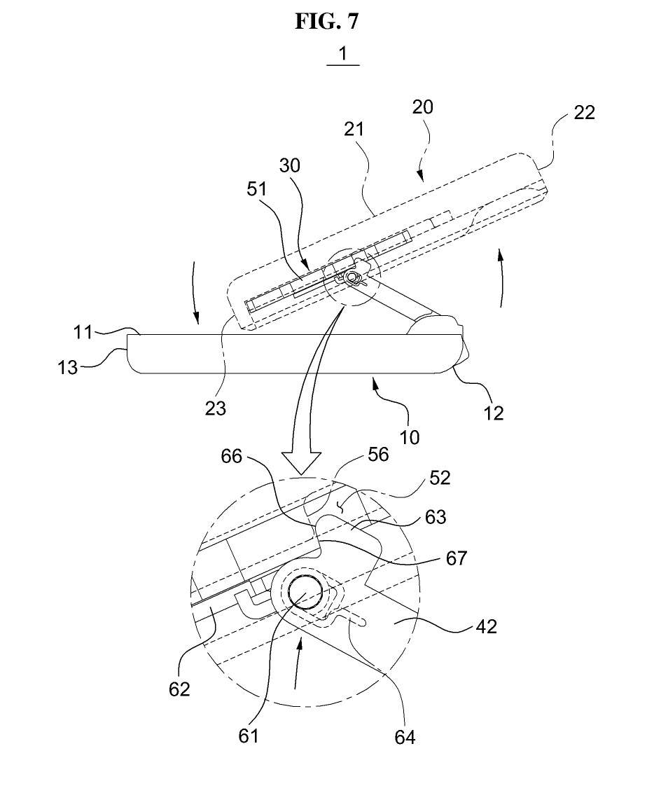

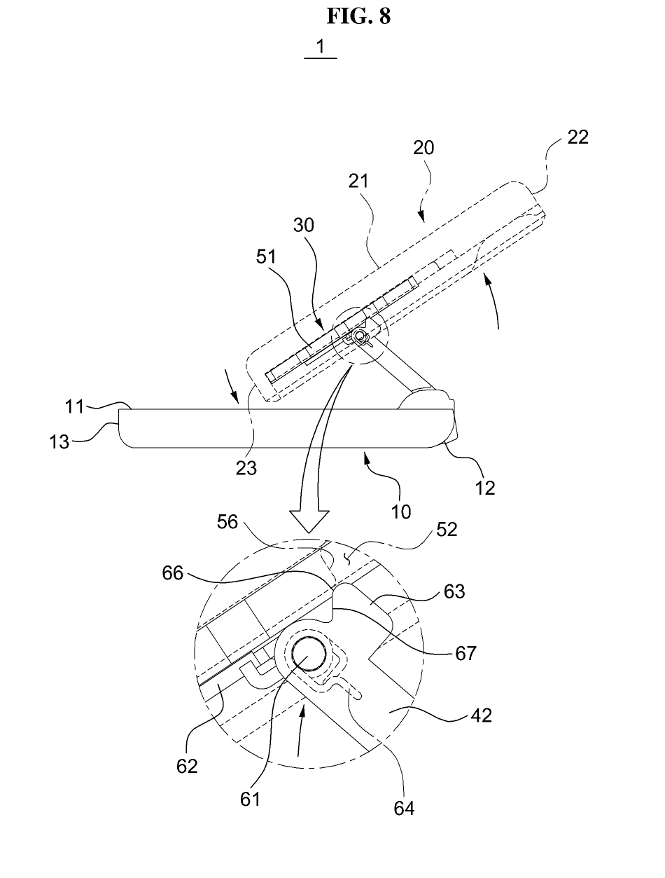

As shown in FIG. 7, the second end of the first plate 42 may be upwardly rotated and the rear end 23 of the second body 20 may continue to move toward the first body 10, and thereby the operative protrusion 63 may be separated from the sliding groove 52, as illustrated in FIG. 8. Thereafter, a restriction force for a movement of the third plate 62 connected to the second end of the first plate 42, in which a sliding movement of the third plate 62 is restricted by the operative protrusion 63 inserted into the sliding groove 52, may be removed. Specifically, a sliding force applied to the second body 20 may be converted into a rotation force, and thereby may exceed a curved point at which the first plate 42 and the third plate 62 are automatically rotated and slides, respectively.

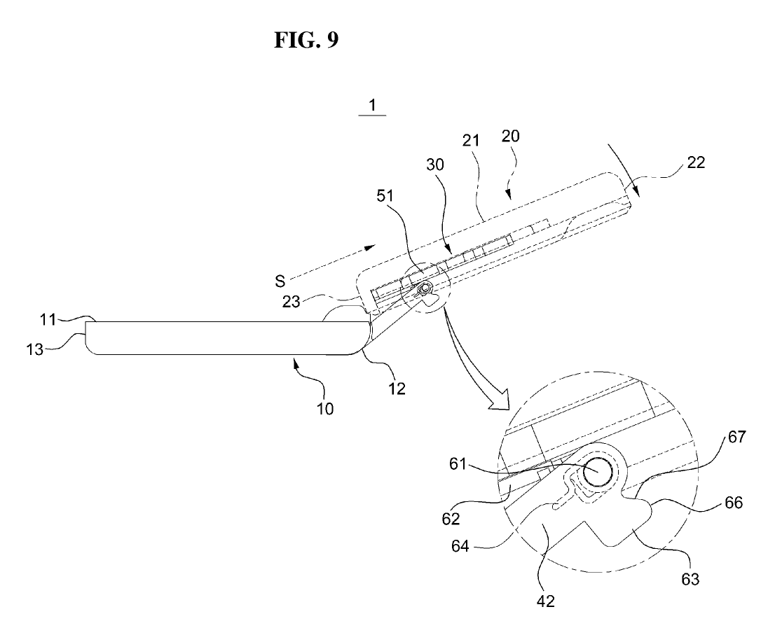

Thereafter, as illustrated in FIG. 9, the first plate 42 may continue to be rotated, and the third plate 62 may be moved along the rail 55 mounted on the both ends of the second plate 51 together with the rotation of the first plate 42. As a result, a movement of the second body 20 to the second position may be completed.

In addition, as illustrated in FIG. 9, the second body 20 may be moved from the second position to the first position by being pressurized towards the first position, i.e., by being subjected to the opposite processes of FIGS. 4 through 9.

The curved-point at which the operative protrusion 63 is separated from the sliding groove 52 to thereby automatically create an inclined sliding force may be adjusted by a length of the sliding groove 52.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A terminal, comprising:
a first body;
a second body facing the first body; and
a sliding apparatus to inclinedly slide the second body with respect to the first body between a first position in which the first body and the second body face each other and a second position in which the second body is inclined with respect to the first body by converting a sliding force exerted in a linear direction to a rotation force in a rotation direction, the sliding force being applied to the second body towards the second position.

2. The terminal of claim 1, wherein the sliding apparatus comprises:
a rotation unit mounted between the first body and the second body to rotate the second body relative to the first body;
a sliding unit to slide the second body in a sliding direction from the first position to the second position, or to slide the second body in a return direction opposite to the sliding direction; and
an operation unit disposed between the rotation unit and the sliding unit to provide an operative force converting the sliding force exerted in the linear direction into the rotation force in the rotation direction.

3. The terminal of claim 2, wherein the sliding unit slides the second body with respect to the first body independent from the rotation unit.

4. The terminal of claim 2, wherein the rotation unit comprises:
a rotation hinge coupled to a front end of the first body; and
a first plate rotatably connected to the first body through the rotation hinge at a first end of the first plate.

5. The terminal of claim 4, wherein the sliding unit comprises:
a second plate disposed on the second body; and
at least one sliding groove formed on the second body to face a side end of the second plate, the at least one sliding groove providing a sliding range through which the second plate slides in the linear direction in parallel with the first body while facing the first body independent from the rotation unit.

6. The terminal of claim 5, wherein the operation unit comprises:
a connection rod rotatably mounted to a second end of the first plate;
a third plate disposed between the second plate and the first body, and rotatably connected to the connection rod at an end of the third plate;
at least one operative protrusion disposed on the second end of the first plate, the at least one operative protrusion being inserted into the at least one sliding groove; and
an elastic body to elastically pressurize a front end of the second body towards the first body,
wherein the sliding force of the sliding unit is converted into the rotation force in the rotation unit if the at least one operative protrusion is separated from the at least one sliding groove.

7. The terminal of claim 5, wherein rails supporting both side ends of the third plate are disposed in both side ends of the second plate.

8. The terminal of claim 1, wherein the first body comprises input keys mounted in a front surface of the first body, and the second body comprises a display panel mounted in a front surface of the second body.

9. A sliding apparatus of a terminal, the sliding apparatus comprising:
a rotation unit to rotate a second body of the terminal relative to a first body of the terminal, the rotation unit being connected between a front end of the first body and a lower surface of the second body facing the first body;
a sliding unit to slide the second body in a sliding direction or in a return direction opposite to the sliding direction; and
an operation unit disposed between the rotation unit and the sliding unit to convert a sliding force of the sliding unit exerted in a linear direction in to a rotation force of the rotation unit.

10. The sliding apparatus of claim 9, wherein the rotation unit, the sliding unit, and the operation unit inclinedly slide the second body relative to the first body between a first position in which the first body and the second body face each other to a second position in which the second body is disposed away from and inclined with respect to the first body.

11. The sliding apparatus of claim 9, wherein:
the rotation unit comprises a first plate rotatably connected to the front end of the first body at a first end of the first plate with respect to the sliding direction,
the sliding unit comprises a second plate disposed on the second body and at least one sliding groove formed on the second body to face a side end of the second plate, the at least one sliding groove providing a sliding range through which the second plate slides in the linear direction in parallel with the first body while facing the first body independent from the rotation unit, and
the operation unit comprises a third plate positioned between the second plate and the first body, the operation unit being slidably connected to the second plate while being rotatably connected to a second end of the first plate;
the first plate comprises at least one operative protrusion extended into the at least one sliding groove; and
an elastic body is disposed between the first plate and the third plate to elastically pressurize a front end of the second body towards the first body, the at least one operative protrusion converting the sliding force of the sliding unit into the rotation force of the rotation unit if being separated from the at least one sliding groove.

12. The sliding apparatus of claim 11, wherein the operation unit comprises a connection rod axis-connected to the second end of the first plate and inserted into a rod hole formed in an end of the third plate.

13. The sliding apparatus of claim 11, wherein the second plate and the third plate slide by a rail that supports both side ends of the second and third plates.

14. A sliding apparatus of a terminal, the sliding apparatus comprising:
a first plate rotatably connected to a front end of a first body of the terminal, the first plate being connected to the first body at a first end of the first plate;
a second plate disposed on a lower surface of a second body of the terminal, the lower surface of the second body facing the first body; and
a third plate rotatably connected to a second end of the first plate and slidably connected to the second plate, the second end of the first plate being opposite the first end of the first plate.

15. The sliding apparatus of claim 14, wherein the first plate comprises operative protrusions disposed at the second end of the first plate to change a sliding force of the second body into a rotation force.

16. The sliding apparatus of claim 14, wherein the second plate comprises rails by which the third plate is slidably connected to the second plate.

17. The sliding apparatus of claim 14, wherein the first plate, the second plate, and the third plate inclinedly slide the second body relative to the first body between a first position in which the first body and the second body face each other to a second position in which the second body is disposed away from and inclined with respect to the first body.
